(19) United States
(12) Patent Application Publication
(10) Pub. No.: US 2009/0192686 A1
(43) Pub. Date: Jul. 30, 2009

(54) Method and Driver Assistance System for Sensor-Based Drive-Off Control of a Motor Vehicle

(76) Inventors: Wolfgang Niehsen, Bad Salzdetfurth (DE); Henning Voelz, Stuttgart (DE); Wolfgang Niem, Hildesheim (DE); Avinash Gore, Düsseldorf (DE); Stephan Simon, Sibbesse (DE)

Correspondence Address: KENYON & KENYON LLP, ONE BROADWAY, NEW YORK, NY, 10004, US

(21) Appl. No.: 11/988,076

(22) PCT Filed: Aug. 11, 2006
(86) PCT No.: PCT/EP2006/065245

§ 371 Date: Mar. 3, 2009

(30) Foreign Application Priority Data
Sep. 21, 2005 (DE) 10 2005 045 017.2

(51) Int. Cl. G05D 1/02; G06K 9/00

(52) U.S. Cl. 701/70; 382/104

(57) ABSTRACT

A method for controlling the drive-off of a motor vehicle in which the area in front of the vehicle is sensed using a sensor device and a drive-off enabling signal is automatically output after the vehicle stops, if the traffic situation allows. Features of the road in the area in front of the vehicle are extracted from the data of the sensor device, and on the basis of these features, at least one enable criterion is checked, a positive result indicating that the road is clear.

### FIELD OF THE INVENTION

The present invention relates to a method for controlling the drive-off of a motor vehicle, the area in front of the vehicle being sensed by a sensor device, and after the vehicle stops, a drive-off enabling signal is output when the traffic situation allows, as well as a driver assistance system for implementing this method.

### BACKGROUND INFORMATION

An example of a driver assistance system in which such a method is used is a so-called ACC (adaptive cruise control) system which allows not only cruise control at a driver-selected speed but also allows automatic distance regulation when the sensor device has located a preceding vehicle. The sensor device is typically formed by a radar sensor, but there are also conventional systems in which a monocular or binocular video system is provided instead of or in addition to the radar sensor. Sensor data are analyzed electronically and form the basis for regulation by using an electronic regulator that intervenes in the vehicle's drive system and brake system.

Advanced systems of this type should also offer increased comfort in stop-and-go situations, e.g., in traffic congestion on a highway, and therefore have a stop-and-go function which makes it possible to brake the host vehicle automatically to a standstill when the preceding vehicle stops, and to automatically initiate a drive-off operation when the preceding vehicle begins to move again. However, there are critical safety aspects to automatic initiation of a drive-off operation because it is essential to ensure that there are no pedestrians or other obstacles on the road directly in front of the vehicle.

In conventional ACC systems, obstacle detection is performed by using algorithms that search in the sensor data for features characteristic of certain classes of obstacles. The conclusion that the road is clear and thus the drive-off operation may be initiated is then drawn from the negative finding that no obstacles have been located.

German Patent Application No. DE 199 24 142 criticizes the fact that the conventional methods for detecting obstacles do not always offer the required safety, in particular in those cases in which the preceding vehicle, which has previously been tracked as a target object has been lost due to the vehicle turning off or pulling out. It is therefore proposed that, when analysis of the sensor data reveals that a drive-off operation should be initiated, at first the driver merely receives a drive-off instruction but the actual drive-off operation is initiated only after the driver has confirmed the enabling of the drive-off. However, in traffic jams in which frequent start-and-stop situations are to be expected, frequent occurrence of such drive-off instructions is often perceived as annoying.

### SUMMARY

An example method according to the present invention may offer increased safety in automatic detection of situations in which a drive-off operation is safely possible.

The example method according to the present invention is not based or at least is not exclusively based on detection of obstacles on the basis of predetermined features of obstacles but instead is based on positive detection of features characteristic of an obstacle-free road. This has the advantage over traditional methods for obstacle detection that, in defining the criterion of the road being clear, it is not necessary to know from the beginning which types of obstacles might be on the road and on the basis of which features these obstacles would be detectable. This example method is therefore more robust and selective as it also responds to obstacles of an unknown type.

More specifically, the criterion for an obstacle-free road is that the sensors involved must directly recognize whether the road is clear in the relevant distance range, i.e., that the view of the road is not distorted by any obstacles. Regardless of the sensor systems involved, e.g., radar systems, monocular or stereoscopic video systems, range imagers, ultrasonic sensors and the like as well as combinations of such systems, an obstacle-free road may be characterized in that the sensor data is dominated by an “empty” road surface, i.e., an extensive area with little texture, although it is interrupted by the conventional road markers and edges having a known geometry. If such a pattern is detected with sufficient clarity in the sensor data, then it is possible to rule out with a high degree of certainty that there are any obstacles, regardless of type, on the road.

The check of the “clear road” criterion may optionally be based on the entire width of the road or only a selected portion of the road, e.g., the so-called driving corridor within which the host vehicle will presumably be moving. Methods for determining the driving corridor, e.g., on the basis of the road curvature derived from the steering angle, on the basis of video data, etc., are conventional.

With the decisions to be made, e.g., the decision about whether a drive-off instruction is to be output to the driver or a decision about whether a drive-off operation is to be triggered with or without driver confirmation, the incidence of wrong decisions may be reduced significantly by using this criterion. Because of its high selectivity, this example method is suitable in particular for deciding whether a drive-off operation may be initiated automatically, without acknowledgment of the drive-off command by the driver. With the example method according to the present invention, errors are most likely to occur in the form of not recognizing a clear road as being clear, e.g., because of repaired locations in the road surface or wet spots on the road surface simulating a structure which does not actually constitute a relevant obstacle. If a drive-off instruction is output in such rare incidents, the driver may easily correct the error by confirming the drive-off command after being certain that the road is clear. In most cases, however, there is automatic recognition of whether the road is clear so that no intervention by the driver is necessary.

The sensor device preferably includes a video system, and one or more criteria that must be met for a clear road are applied to features of the video image of the road.

Analysis of the video image is suitably performed by line-based methods, e.g., analysis of video information on so-called scan lines running horizontally in the video image, each thus representing a zone in the area in front of the vehicle at a constant distance from the vehicle as seen in the direction of travel, or optionally information on scan lines running parallel to the direction of travel (i.e., in the direction of the vanishing point in the video image); region-based methods in which two dimensional regions in the video image are analyzed are also suitable.

It is expedient to ascertain the gray value or color value within the particular lines or regions of the video image, because the road surface (apart from any markings) is characterized by an essentially uniform color and brightness.

A helpful instrument for analyzing the video image is creation of a histogram for the color values or gray values. The dominance of the road surface in the histogram results in a pronounced single peak for the gray value corresponding to the road surface. However, a distributed histogram without a pronounced dominance of a single peak indicates the presence of obstacles.

Such a histogram may be created for scan lines as well as for certain regions of the video image or the image as a whole.

Another (line-based) method is detection and analysis of edges in the video image. Straight edges and lines such as road markers and road edges running in the plane of the road surface in the longitudinal direction of the road have the property that when they are prolonged, they intersect at a single vanishing point. However, edges and lines representing the lateral borders of objects that are elevated with respect to the road surface do not have this property. It is thus possible to decide by analyzing the points of intersection of the prolonged edges whether the video image represents only the empty road or whether there are obstacles.

Examples of conventional algorithms for region-based analysis of a video image include so-called region growing and texture analysis. Contiguous regions in an image having similar properties, e.g., an empty road surface, may be recognized by using region growing. However, if the view of parts of the road surface is distorted by obstacles, the result in region-growing is not a contiguous region or at least not a simply contiguous region but instead a region having one or more “islands.” In texture analysis, a texture measure is assigned to the video image as a whole or to individual regions of the video image. A clear road is characterized by little texture and thus by a small texture measure, whereas obstacles in the video image result in a higher texture measure.

It is expedient to combine multiple analytical methods, such as those described above, as an example. For each analytical method, a separate criterion is then established for an obstacle-free road and it is assumed that the road is clear only when all of these criteria are met.

This method may be further refined by using conventional object recognition algorithms if at least one criterion for a clear road is not met, in an attempt to identify and characterize more precisely the object causing the criterion not to be met, so that it is possible to decide whether this object is actually a relevant obstacle. In object recognition, data from different sensor systems (e.g., radar and video) may be merged.

It is also possible that, before applying the criterion or criteria for a clear road, preprocessing of the sensor data is performed to filter out in advance the typical interfering influences that are known not to represent true obstacles. This is true, for example, of road markers and areas on the right and left upper edge of the image that are typically outside of the road.

### BRIEF DESCRIPTION OF THE DRAWINGS

Exemplary embodiments of the present invention are depicted in the figures and described in greater detail below.

FIG. 1 shows a block diagram of a driver assistance system according to the present invention.

FIGS. 2 and 3 show diagrams illustrating a line-based method for analyzing a video image.

FIG. 4 shows a histogram for a clear road.

FIG. 5 shows a histogram for a road having an obstacle.

FIG. 6 shows a graphic representation of the result of a region-growing operation for a road having an obstacle.

FIG. 7 shows a differential image used for motion analysis.

FIGS. 8 and 9 show diagrams illustrating methods of motion analysis on the basis of an optical flow.

FIG. 10 shows a flow chart for an example method according to an embodiment of the present invention.

### DETAILED DESCRIPTION OF EXAMPLE EMBODIMENTS

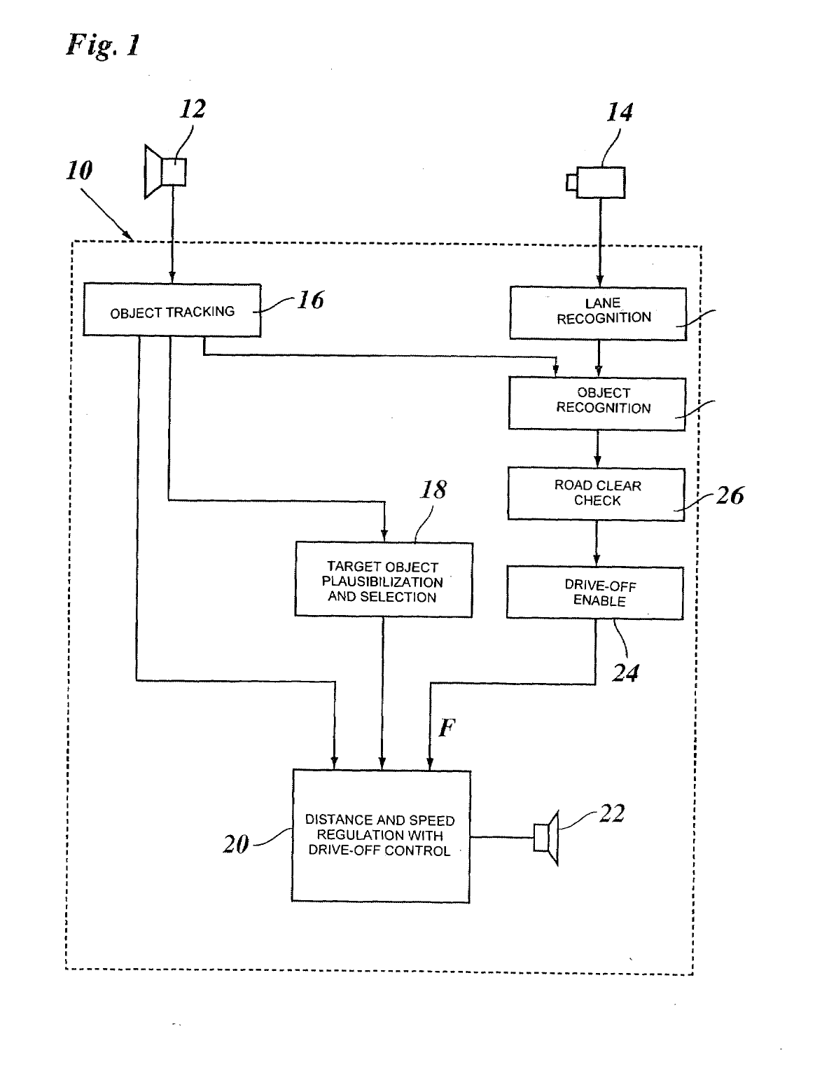

As an example of a driver assistance system, FIG. 1 shows an ACC system 10 that analyzes data from radar sensor 12 and a video camera 14. The radar sensor and the video camera are installed in the vehicle in such a way that they monitor the area in front of the vehicle. On the basis of data from radar sensor 12, objects that have produced a radar echo are identified in a tracking module 16; these objects are then combined in an object list and their location and motion data are tracked over successive measurement cycles of the radar sensor. If at least one object has been located, a decision is made in a plausibility check module 18 to determine whether one of the located objects is a directly preceding vehicle in one's own lane, and this object is selected as a target object for the cruise control. Actual distance regulation is then performed on the basis of data about the target object supplied by tracking module 16 in a regulator 20, which, like the components of the ACC system, is preferably implemented as software in an electronic data processing system. Regulator 20 intervenes in the vehicle's drive system and brake system to regulate its speed, so the target object is followed at an appropriate interval of time.

If there is no target object, the speed is regulated at the desired speed selected by the driver.

Regulator 20 of the ACC system described here has a so-called stop-and-go function, i.e., it is capable of braking the host vehicle even to a standstill when the target object stops. Regulator 20 is likewise capable of controlling an automatic drive-off operation when the target object is in motion again or migrates laterally out of the locating range of the radar sensor because of a turning or pulling out operation. Under certain conditions the drive-off operation is not initiated automatically, however, but instead a drive-off instruction is merely output to the driver via a man-machine interface 22, and the drive-off operation is only initiated when the driver confirms the drive-off command. The decision about whether a drive-off operation may be initiated automatically and immediately or only after confirmation by the driver is made by an enable module 24 on the basis of the results of a check module 26 which primarily analyzes the image recorded by video camera 14 to ensure that there are no obstacles on the road in the drive-off area. If the road is clear, the enable module 24 delivers a drive-off enabling signal F to regulator 20. The regulator then initiates the automatic drive-off operation (without drive-off instruction) only if drive-off enabling signal F is received and, if necessary, also checks on other conditions that must be met for an automatic drive-off operation, e.g., the condition that no more than a certain period of time of three seconds, for example, has elapsed since the vehicle came to a standstill.

In the example presented here, an object recognition module 28 and a lane recognition module 30 are also connected upstream from check module 26.

In object recognition module 28, the video image is checked for the presence of certain predefined classes of objects that may be considered as an obstacle, e.g., passenger vehicles and trucks, motorcycles, bicycles, pedestrians, and the like. These objects are characterized in a conventional manner by defined features for which a search is then conducted in the video image. Furthermore, in the example presented here, data from video camera 14 are merged with data from radar sensor 12 in object recognition module 28, so that an object located by the radar sensor may be identified in the video image and vice-versa. It is then possible, for example, to identify an object located by the radar sensor in object recognition module 28 on the basis of the video image as being a tin can lying on the road, for example, which does not constitute a relevant obstacle. However, if object recognition module 28 recognizes an object and evaluates it as being a real obstacle, the check in check module 26 may be skipped and enable module 24 instructed to allow an automatic drive-off operation only after driver confirmation or, alternatively, not to output any drive-off instruction to the driver.

Lane recognition module 30 is programmed to recognize certain predefined lane markers in the video image, e.g., right and left lane edge markers, continuous or interrupted center stripes or lane markers, stopping lines at intersections and the like. Recognition of such markers facilitates and improves the checking procedure in check module 26 as described below. In addition, the result of lane recognition may also be used in plausibility check module 18 to improve the assignment of objects located by radar sensor 12 to the different lanes.

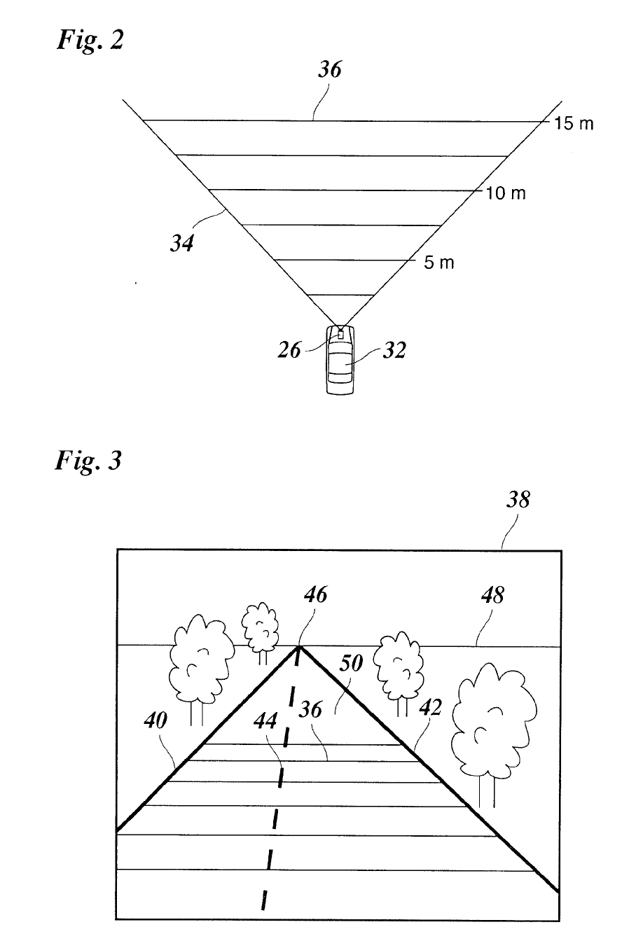

Check module 26 performs a number of checks on the video image of video camera 14 with the goal of recognizing features that are specifically characteristic of a clear lane, i.e., that do not occur when a lane is obstructed by obstacles. An example of one of these check procedures will now be explained on the basis of FIGS. 2 through 5.

FIG. 2 shows a schematic diagram of a vehicle 32 equipped with ACC system 10 according to FIG. 1 as well as area 34 in front of video camera 14, i.e., the area of the road surface and the adjacent terrain visible in the video image. This area 34 in front of the vehicle is divided into a plurality of strips or lines 36 (scan lines) running across the longitudinal axis of vehicle 32, corresponding to different distances from vehicle 32, e.g., five meters, ten meters, etc.

FIG. 3 shows the corresponding video image 38. Lane markers 40, 42 and 44 for the right and left borders of the road and a center strip are shown. These marking lines appear as straight lines in the video image, all of which intersect at a vanishing point 46 on horizon 48. Lines 36, already described in conjunction with FIG. 2, are shown on road surface 50.

Various criteria are now available for the decision that the road is clear in the lower distance range relevant for the drive-off operation (as in FIG. 3). One of the criteria is that in the relevant distance range the pixels of lines 36, which are entirely or predominantly within road surface 50, practically all (apart from image noise) have a uniform color, namely the color of the road surface. In the case of a black and white image, the same thing is true of the gray value. Various algorithms that are already known in principle are available for testing this criterion.

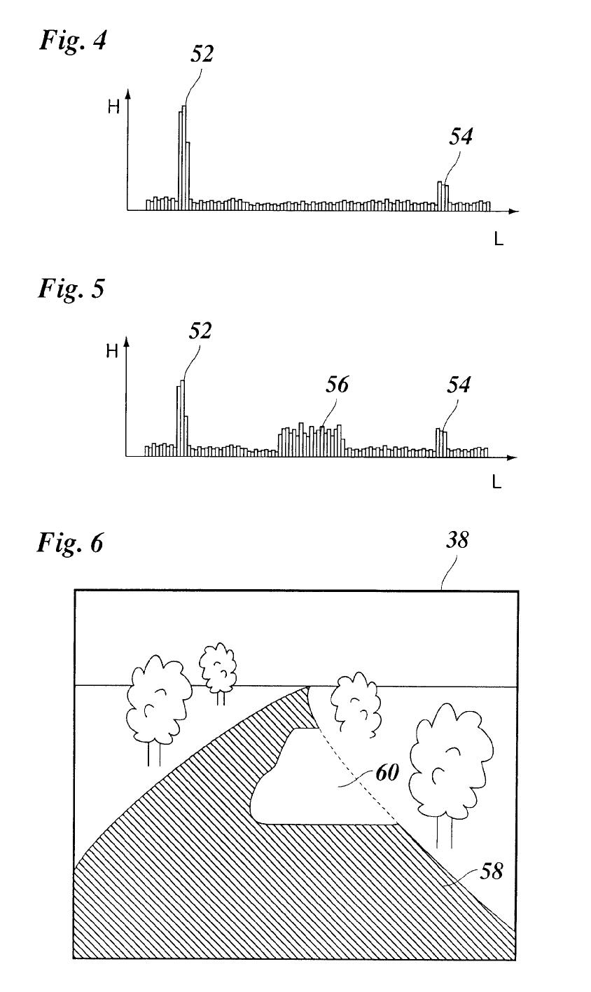

A histogram analysis like that shown in FIGS. 4 and 5 is particularly expedient here. In such a histogram, which may be created for each line 36, the number of pixels of the particular line each having possible brightness value L (luminance) is given. In the case of a color image, a corresponding histogram may be created for each of three primary colors R, G and B.

FIG. 4 shows a typical example of a histogram for a clear road. It is characteristic of this that there is only one very pronounced peak 52 in the histogram representing the brightness value of road surface 50. A weaker peak 54 at very high brightness values represents white road markers 40, 42, 44.

FIG. 5 shows for comparison a corresponding histogram for a road on which there is at least one unknown obstacle. Peak 52 is less pronounced here, and in particular there is also at least one additional peak 56 representing the brightness values of the obstacle.

If the pattern shown in FIG. 4 is obtained when analyzing the histogram for all lines 36 in the relevant distance range, it is possible to be certain that the road is clear.

If, as shown in FIG. 1, there is a lane recognition module, then the selectivity of the method may be further increased by blanking out the recognized road markers from the image, so that peak 54 in the histogram disappears. In addition, it is possible to cut video image 38 (FIG. 3) before the line-based analysis, so that the image areas typically outside of road surface 50 are blanked out in particular when there are greater distances. This is of course particularly simple when road markers 40 and 42 for the left and right edges of the road have already been recognized in lane recognition module 30.

In an alternative embodiment, it is of course also possible to perform the histogram analysis not on the basis of individual lines 36, but instead for the entire image or for a suitably selected portion of the image.

Another criterion for the decision that the road is clear is based on conventional algorithms for recognizing edges or lines in a video image. In the case of a clear (and straight) road, in particular when the image is trimmed appropriately in the manner described above, the single edges or lines should be those produced by the road markers and road edges and, if necessary, the curb edges and the like. As already mentioned, these have the property that they all intersect at vanishing point 46 (in the case of a curved road, this is true within sufficiently short sections of road in which the lines are approximately straight). If there are obstacles on the road, however, edges or lines occur that are formed by the lateral, approximately vertical borders of the obstacle and do not meet the criteria that they intersect at vanishing point 46. Furthermore, in the case of obstacles, man-made objects in particular, there are typically also horizontal lines or edges which are not present on a clear road, however, apart from stopping lines running across the road, which may be recognized by lane recognition module 30.

An example of a region-based analysis is a region-growing algorithm. This algorithm begins by first determining the properties, e.g., the color, the gray value or the fine texture (roughness of the road surface) for a relatively small image area, preferably in the lower portion of the middle of the image. If the road is clear, this small region will represent a portion of road surface 46. This region is then gradually prolonged in all directions in which the properties correspond approximately to those of the original region.

Finally, this yields a region corresponding to the totality of road surface 50 visible in the video image.

In the case of a clear road, this region should be a contiguous area without interruptions or islands. Depending on the spatial resolution, interrupted road markers 44 for the center stripe might be represented as islands if they have not been eliminated by lane recognition module 30. However, if there is an obstacle on the road, the region will have a gap instead of the obstacle, as shown on the example in FIG. 6. Region 58 obtained as the result of the region-growing operation is shown with hatching in FIG. 6, having a gap in the form of a bay 60 caused by an obstacle such as a vehicle.

With another obstacle configuration, the obstacle(s) might divide region 58 into two completely separate areas. To cover such cases, it is possible to also have region growing (for the same properties) start from different points in the image. However, such configurations do not generally occur in the area directly in front of one's vehicle, which is all that is important for the drive-off operation. Obstacles here are therefore represented either as islands or bays (as in FIG. 6).

A simple criterion for the finding that the road is clear is therefore that region 58 obtained as the result of region growing is convex in the mathematical sense, i.e., any two points inside this region are connectable by a straight line which is also entirely inside this region. This criterion is based on the simplifying assumption that the borders of the road are straight. This assumption is largely met, at least in the near range. A refinement of the criterion might be to approximate the lateral borders of region 58 by polynomials of a low degree, e.g., parabolas.

Another criterion for finding that the road is clear is based on a texture analysis of the video image, either for the image as a whole or for suitable selected partial areas of the image. Road surface 50 has practically no texture apart from a fine texture which is due to the roughness of the road surface and may be eliminated through a suitable choice of texture filter. Obstacles on the road, however, result in the image or the observed partial area of the image having a much greater texture measure.

Use of a trained classifier is also possible with the region-based criteria. Such classifiers are adaptive analytical algorithms trained in advance by using defined exemplary situations, then being capable of recognizing with a high reliability whether the analyzed image detail belongs to the trained class “road clear.”

A necessary but not sufficient criterion for the road being clear is also that there must be no motion, in particular no transverse motion, in the relevant image detail corresponding to the area directly in front of the vehicle. The image portion should be limited so that motion of people visible through the rear window of the preceding vehicle is disregarded. If longitudinal motion is also taken into account, then motion in the video image resulting from the preceding vehicle driving off is also to be eliminated.

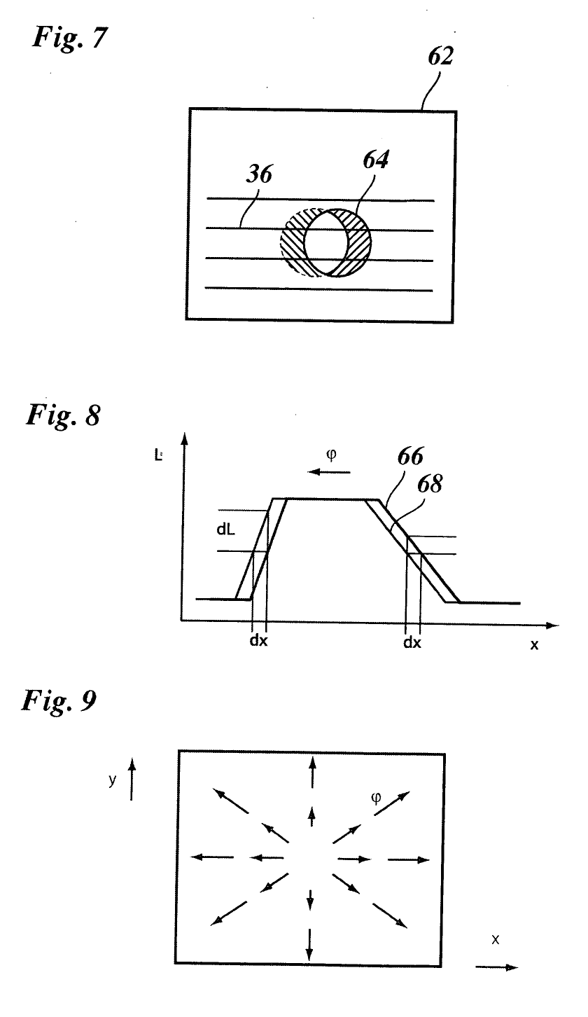

When the host vehicle is stopped, motion is easily recognizable by analyzing the differential image between two video images recorded in close succession. If there is no motion, the differential image (e.g., the difference between the brightness values of the two images) will have a value of zero. However, FIG. 7 shows as an example a differential image 62 of a ball 64 rolling across the road. The motion of the ball causes two sickle-shaped zones having a brightness difference which is different from zero, represented by hatching in FIG. 7. If only transverse motion is to be recognized, the analysis may again be limited to horizontal lines 36 (scan lines). If the requirement is that motion must be recognized in at least two lines 36, then the minimum size of the moving objects to be recognized as an obstacle may be preselected by the spacing of lines 36.

A differentiated motion detection method is based on calculation of so-called optical flow. Optical flow is a vector field indicating the absolute value and direction of motion of structures in the video image.

One possibility of calculating the optical flow is illustrated in FIG. 8 for the one-dimensional case, i.e., for optical flow j in horizontal direction x of the video image, i.e., for motion across the direction of travel. Curve 66 shown in bold in FIG. 8 indicates brightness L (of one image line) as a function of coordinate x. In the example shown here, the object has a relatively high constant brightness value in a central area, with the brightness declining differently on the right and left flanks. Curve 68, shown with a thinner line in FIG. 8, illustrates the same brightness distribution after a short period of time dt, during which the object has moved distance dx to the left. Optical flow j characterizing the motion of the object is defined by j=dx/dt.

Spatial derivation dL/dx of brightness and time derivation dL/dt may be formed on the flanks of the brightness curve, where the following formula applies:

dL/dt=j·(dL/dx).

If dL/dx is not equal to zero, then optical flow j may be calculated as:

j=(dL/dt)/(dL/dx).

This analysis may be performed for each individual pixel on one or more lines 36 or for the entire video image, yielding the spatial distribution of the longitudinal or x component of flow j in the image areas in question.

The vertical or y component of the optical flow may be calculated by a similar method, thus ultimately yielding a two-dimensional vector field reflecting the motion of all structures in the image. For a motionless scene, the optical flow must disappear everywhere, except for image noise and calculation inaccuracies. If there are moving objects in the image, the distribution of the optical flow makes it possible to recognize the shape and size of the objects as well as the absolute value and direction of their motion in the x-y coordinate system of the video image.

This method may also be used to recognize moving objects when the host vehicle is in motion. Motion of the host vehicle, namely when the road is clear, results in a characteristic distribution pattern of optical flow j, as represented schematically in FIG. 9. Deviations from this pattern indicate the presence of moving objects.

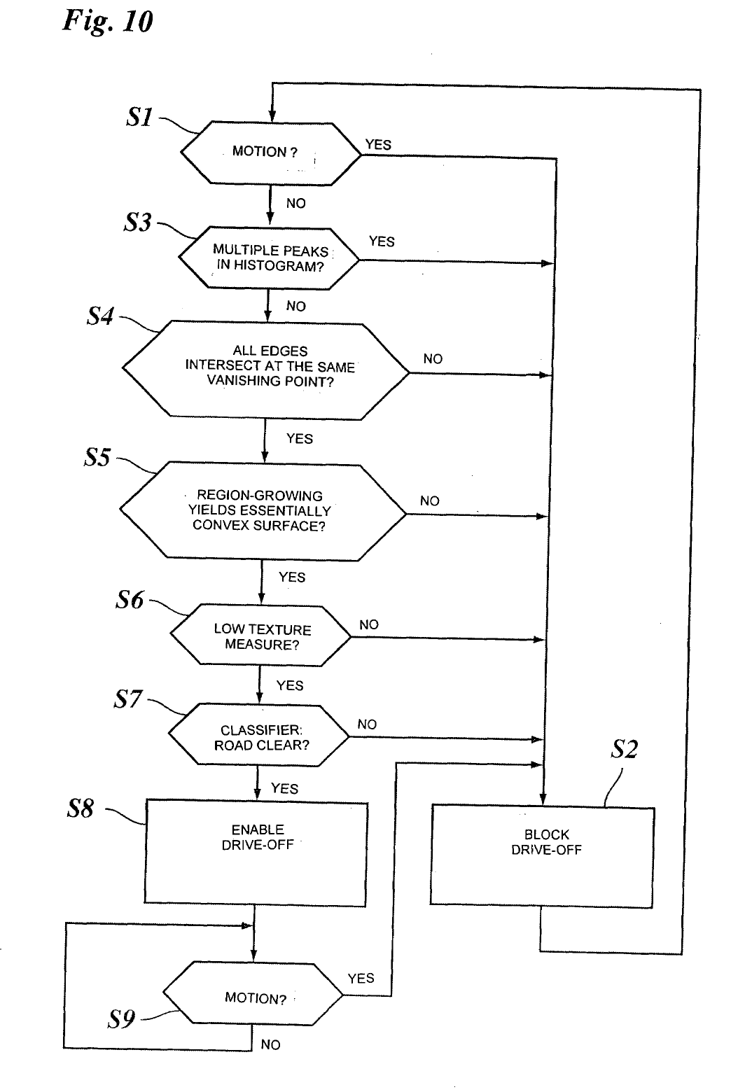

FIG. 10 shows a flow chart of an example of a method to be implemented in check module 26 in FIG. 1, combining the check criteria described above.

In step S1, differential image analysis or calculation of the optical flow is used to determine whether there are any moving objects, i.e., potential obstacles in the relevant portion of the video image. If this is the case (Y), this partial criterion for a clear road is not met, the method branches off to step S2, and enable module 24 is caused to block the automatic initiation of the drive-off operation. Only a drive-off instruction is then output and the drive-off operation begins only when the driver subsequently confirms the drive-off command.

Otherwise (N), histogram analysis is used in step S3 to reveal whether there are multiple peaks for at least one of lines 36 in the histogram (as in FIG. 5).

If the criterion checked in step S3 is met (N), then a check is performed in step S4 to determine whether all the straight edges identified in the image intersect in a single vanishing point (according to the criterion explained above on the basis of FIG. 3). If this is not the case, the method branches back to step S2.

Otherwise, in step S5 the method checks on whether region growing yields an essentially convex surface (i.e., apart from the curvature of the edges of the road). If this is not the case, the method jumps back to step S2.

Otherwise, in step S6 the method checks on whether the texture measure ascertained for the image is below a suitably selected threshold value. If this is not the case, the method branches back to step S2.

Otherwise, in step S7 the method checks on whether the trained classifier recognizes the road as being clear. If this is not the case, the method again branches back to step S2. However, if the criterion in step S7 is also met (Y), this means that all the checked criteria point to the road being clear, and drive-off enabling signal F is generated in step S8 and thus automatic initiation of the drive-off operation is allowed without prior drive-off instruction.

Following that, at least as long as the vehicle has not yet actually driven off, a step S9 is executed cyclically in a loop to detect motion in the video image, as was done in step S1. If an obstacle is moving in the area in front of the vehicle in this stage, it is detected on the basis of its motion and the method exits the loop with step S2, so the drive enablement is canceled again.

Following step S2, the method jumps back to step S, where motion is again detected. Steps S1 and S2 are repeated in a loop as long as motion persists. If motion is no longer detected in step S, the method exits the loop via step S3 and a check is performed in steps S3 through S7 to determine whether the obstacle is still on the road or the road is now clear.

To eliminate unnecessary computation work, in a modified embodiment, a flag may always be set when step S2 is reached via one of steps S3 through S7, i.e., when a motionless obstacle has been detected. This flag then causes step S1 to branch off to step S2 when there is a negative result (N), and to also branch off to step S2 when there is a positive result (Y) and, in addition, to reset the flag. This is based on the consideration that the obstacle cannot disappear from the road without moving. The method then exits loop S1-S2 via step S3 as soon as no more motion is detected.

1-15. (canceled)

16. A method for controlling the drive-off of a motor vehicle, comprising:
sensing an area in front of the vehicle using a sensor device;
after the vehicle has stopped, automatically outputting a drive-off enabling signal if a traffic situation allows;
extracting features of a road in the area in front of the vehicle from data of the sensor device; and
checking at least one enable criterion based on the features, which positively indicates that the road is clear.

17. The method as recited in claim 16, wherein the data of the sensor device include a video image from which the features of the road are extracted.

18. The method as recited in claim 17, wherein at least one enable criterion requires an image of a uniform road surface to be dominant in the video image.

19. The method as recited in claim 18, wherein the enable criterion is checked based on lines in the video image, each of which corresponds to a zone of the road surface at a certain distance in front of the vehicle.

20. The method as recited in claim 18, wherein the enable criterion is checked via histogram analysis.

21. The method as recited in claim 18, wherein the enable criterion includes a criteria that a region corresponding to the road surface is clear of islands or bays in the video image, and the check of the criterion includes a region-growing operation.

22. The method as recited in claim 18, wherein the check of the enable criterion includes a texture analysis.

23. The method as recited in claim 17, wherein the features extracted from the video image include straight lines, and the enable criterion includes a criteria that the image contains only lines, prolongations of which intersect at a single vanishing point.

24. The method as recited in claim 17, wherein the video image is analyzed by using a classifier trained on a clear road and the enable criterion includes a criteria that the classifier detects a clear road.

25. The method as recited in claim 17, wherein an object recognition procedure is applied to the video image to recognize objects in the video image based on predefined features.

26. The method as recited in claim 25, wherein the object recognition procedure includes a search for predefined features of obstacles and, if features of an obstacle are detected, automatic output of the drive-off signal is suppressed without further checking of the enable criteria.

27. The method as recited in claim 25, wherein the object recognition procedure includes a search for predefined features of objects which are not obstacles and the features thus recognized are not taken into account in checking the enable criteria.

28. The method as recited in claim 25, wherein the video image is subjected to a motion analysis and objects are recognized based on their motion in the video image.

29. The method as recited in claim 16, wherein multiple enable criteria are checked and automatic output of the drive-off enabling signal is suppressed if at least one of these criteria is not met.

30. A driver assistance system for a motor vehicle, comprising:
a sensor device adapted to sense an area in front of the motor vehicle after the vehicle has stopped;
an element adapted to automatically assist a drive-off enable signal if a traffic situation allows;
an element adapted to extract features of a road in the front of the motor vehicle from data of the sensor device; and
an element adapted to check at least one enable criterion based on the extracted features, and positively indicates the road is clear.
